(19) United States
(12) Patent Application Publication
(10) Pub. No.: US 2013/0135674 A1
(43) Pub. Date: May 30, 2013

(54) NETWORK CONNECTABLE DEVICE AND METHOD OF CHANGING DEVICE'S OWN NAME

(71) Applicant: Kazunori Hirabayashi, Kanagawa-ken (JP)

(72) Inventor: Kazunori Hirabayashi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/685,885

(22) Filed: Nov. 27, 2012

Related U.S. Application Data
(60) Provisional application No. 61/564,384, filed on Nov. 29, 2011.

(51) Int. Cl. G06K 15/02

(52) U.S. Cl. CPC G06K 15/02
USPC 358/1.15

(57) ABSTRACT

A network connectable device in an embodiment includes a memory, a processor, and an interface. The memory pre-stores the name information of the network connectable device. The processor acquires the name information from the memory, adds first information including a prescribed character or character string to the beginning of the name information, and stores the resultant name information in the memory. The interface receives an electronic message and sends the name information stored in the memory and having the first information added to the beginning.

### CROSS-REFERENCE TO RELATED APPLICATIONS

This application is based upon and claims the benefit of priority from: U.S. provisional application 61/564,384, filed on Nov. 29, 2011; the entire contents all of which are incorporated herein by reference.

### FIELD

Embodiments described herein relate generally to a technique for detecting a device in a network.

### BACKGROUND

Conventionally, to register an image forming device such as a printer or an MFP (Multifunction Peripheral) having a printer function from a computer, the computer uses, for example, a printer registration wizard to detect printers and MFPs in the network. The user selects a printer or MFP to be used from a list of the detection results. The list of the detection results is often in alphabetical order.

With the widespread proliferation of mobile wireless terminals and the development of zero configuration technology, occasions on which printing is performed directly through a network are increasing. In such a technology, printers in a network are dynamically listed. Therefore, when a plurality of printers and MFPs are present in the network, a long list is displayed on a printer selection screen. It is difficult to find and select the desired printer from such a long list.

### DESCRIPTION OF THE DRAWINGS

FIG. 1 is a diagram illustrating an example of the configuration of, a printing system in an embodiment.

FIG. 2 is a diagram illustrating an example of the hardware configuration of an MFP in the embodiment.

FIG. 3 is a flowchart showing an example of an operation in a first embodiment.

FIG. 4 is a diagram illustrating an example of discovery results when the first embodiment is applied.

FIG. 5 is a flowchart showing an example of an operation in a second embodiment.

FIG. 6 is a diagram illustrating an example of the operation in the second embodiment.

FIG. 7 is a flowchart showing an example of an operation in a third embodiment.

FIG. 8 is a flowchart showing an example of an operation in a fourth embodiment.

FIG. 9 is a diagram illustrating an example of discovery results when the fourth embodiment is applied.

FIG. 10 is a flowchart showing an example of an operation in a fifth embodiment.

### DETAILED DESCRIPTION

A network connectable device in each of the following embodiments includes a memory, a processor, and an interface. The name information about the device's own name has been stored in the memory. The processor acquires the name information from the memory, adds first information, being a prescribed character or character string, to the beginning of the name information, and stores the resultant name information in the memory. The interface receives an electronic message and sends the name information stored in the memory and having the first information added to its beginning.

### First Embodiment

In each of the following embodiments, a device (MFP) sends a broadcast using the zero configuration technology to acquire the names of other devices and their setting values from these devices. The MFP compares its own name with the obtained names of the other devices. If there is a name alphabetically earlier than the own name of the MFP, the MFP changes the own name so as to be alphabetically earlier than the alphabetically earlier name. In this manner, even when the MFP has an alphabetically later name, the changed name appears high on the list, and the user can easily find the MFP. When the MFP appears high on the list, the frequency of the use of the MFP increases.

A description will next be given of an alphabetical sorting method. Suppose that there are two character strings. First, the first characters of these character strings are acquired and compared with each other, and a character string with the first character having a smaller value in the ASCII code system is placed ahead of the other character string. Suppose that, for example, character strings “Aneto” and “Everest” are alphabetically sorted. The first characters of these character strings are “A” and “E.” Since “A” is smaller in the ASCII code system, the character string “Aneto” is placed ahead of the character string “Everest.” If the first characters are the same, the second characters are compared, and a higher rank is given to a character string with the second character having a smaller value in the ASCII code system. This operation is successively executed until the last characters of the character strings. When sorting is performed on three or more character strings, the above-described processing is performed on these character strings to rank them.

In the ASCII code system, codes have been assigned to characters in alphabetical order in such a manner that “A”=0x41, “B”=0x42, . . . , “Z”=0x5a. Therefore, the use of the magnitude relation between the values of these codes allows alphabetical sorting. In the following description, character strings are compared and sorted in ASCII code order.

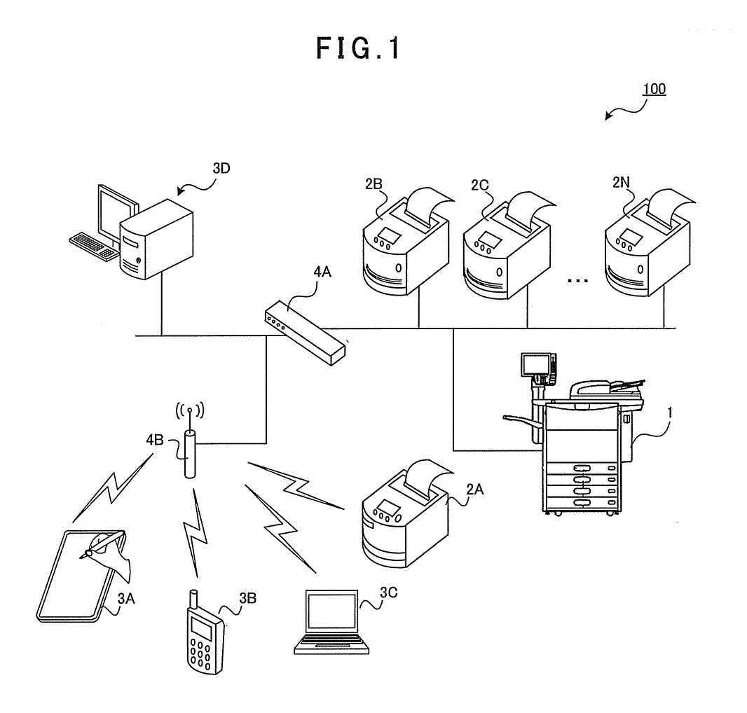

FIG. 1 shows an example of the configuration of a printing system. The printing system 100 includes an MFP (Multifunction Peripheral) 1 and printers 2A to 2N which are network connectable devices, and further includes a tablet PC 3A (PC: Personal computer), a mobile phone 3B, a client PC 3C, and a desktop PC 3D.

The MFP 1, the printers 2B to 2N, and the desktop PC 3D are connected to a switching hub 4A and form a network through cables to allow data communication between these devices. The tablet PC 3A, the mobile phone 3B, the client PC 3C, and the printer 2A are connected to an access point 4B and form a wireless network to allow data communication between these devices. The switching hub 4A and the access point 4B are connected through a cable, and this allows data communication between the respective devices shown in FIG. 1.

The image forming devices such as the MFP 1 and the printers 2A to 2N in this embodiment use the zero configuration technology. For example, when a broadcast is sent from one of the devices 3A to 3D such as the tablet PC 3A or the desktop PC 3D using a discovery protocol, each of the MFP 1 and the printers 2A to 2N sends an electronic message including its device name and setting values in response to the broadcast. The sender of the broadcast receives the electronic reply messages, extracts printer names, and displays the list of the printer names.

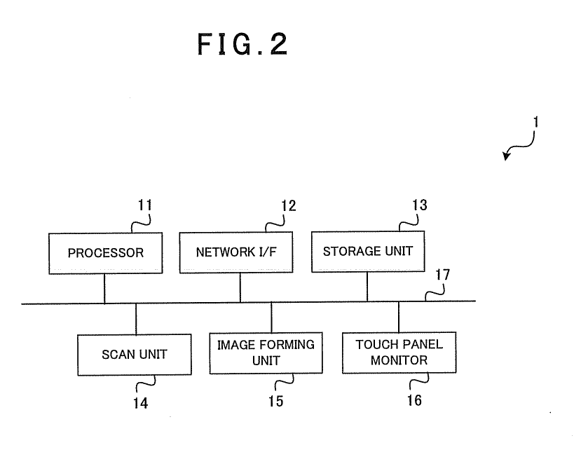

FIG. 2 shows an example of the hardware configuration of the MFP 1, as an example of the hardware configuration of an image forming device in this embodiment. The printers 2A to 2N have a hardware configuration similar to this configuration.

The MFP 1 includes a processor 11 which is an arithmetic processing unit such as a CPU (Central Processing Unit) or an MPU (Micro Processing Unit) and a network I/F 12 (I/F: Interface) which is a LAN card connected to the switching hub 4A through a cable. The MFP 1 further includes a storage unit 13 including a volatile storage unit (a RAM (Random Access Memory)) and non-volatile storage units such as a hard disk and a flash memory. The MFP 1 further includes: a scan unit 14 configured to scan a document sheet, convert it to electronic image data, and store the electronic image data in the storage unit 13; and an image forming unit 15 configured to acquire the image data stored in the storage unit 13 and form a toner image on a sheet. The MFP 1 further includes a touch panel monitor 16 including a display unit configured to display processing details and an input unit configured to detect a finger or a pen point pressed against the input unit to receive an instruction from the user. The transmission and reception of data and control signals between these units are made through a bus 17.

In the following description, it is assumed that, in the printing system 100, the MFP 1 is a high-performance printer and is a printer that a system administrator wants general users to use it as a main printer or a printer that general users want to use it as a main printer. It is also assumed that the MFP 1 has a device name that is ranked low in ASCII code order (i.e., being listed low on the displayed list). A description will be given of an example of an operation that allows the MFP 1 itself to change its device name.

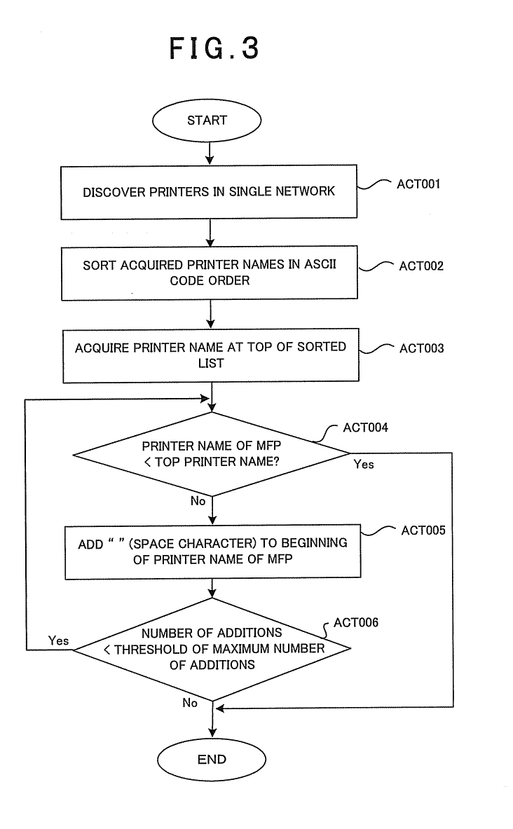

FIG. 3 is a flowchart showing the example of the operation of the MFP 1. The operation in the flowchart is implemented by loading a program pre-stored in a non-volatile area of the storage unit 13 into the processor 11 and executing the program on the processor 11. Generated data and temporary intermediate data generated during the processing are stored in the storage unit 13.

The network I/F 12 sends a broadcast through the network using, for example, the discovery protocol according to an instruction from the processor 11. Upon reception of the broadcast, the printers 2A to 2N send electronic reply messages including their printer names and setting values to the MFP 1 (sender). The network I/F 12 receives the electronic reply messages from the printers 2A to 2N (ACT001). This operation is hereinafter referred to as discovery.

The processor 11 extracts the printer names from the electronic reply messages and sorts the printer names in ASCII code order to generate a list (ACT002). This list is temporarily stored in the storage unit 13. The processor 11 acquires the printer name at the top of the list (ACT003).

The processor 11 acquires the own name of the MFP 1, i.e., the preset printer name for the MFP 1, from the storage unit 13 and compares the acquired printer name at the top of the list with the printer name of the MFP 1 according to the ASCII code system (ACT004). For example, when the character string of the printer name at the top of the list is “A-Printer” and the character string of the own name of the MFP 1 is “B-Printer,” (the own name of the MFP 1 “B-Printer”)>(the top printer name “A-Printer”) holds when these character strings are compared in ASCII code order. If the value of the own name of the MFP 1 is larger than the value of the printer name at the top of the list as described above, i.e., the own name of the MFP 1 is later in alphabetical order (ACT004, No), the processor 11 adds a space character “ ” used as a prefix to the beginning of the printer name of the MFP 1 to change it to “B-Printer” (ACT005).

ACT004 and ACT005 are repeated until the number of additions of a space character exceeds a predetermined threshold value (“Yes” loop in ACT006).

If the value of the own name of the MFP 1 is smaller than the value of the printer name at the top of the list, i.e., the own name of the MFP 1 is earlier in alphabetical order, in the processing in ACT004 (ACT004, Yes), the printer name of the MFP 1 is the alphabetically earliest among the printers in the network. Therefore, the current printer name of the MFP 1 is used without any modification, and the process is ended. In the operation in ACT004 executed after the loop in ACT006, a comparison is made with a space character added to the own name of the MFP 1. If the number of additions of a space character exceeds the predetermined threshold value (ACT006, Yes), the process is ended.

The changed printer name of the MFP 1 is overwritten and stored in the storage unit 13 and is then used as the printer name of the MFP 1. When the discovery is performed on the devices 3A to 3D, the MFP 1 sends an electronic reply message including the changed printer name.

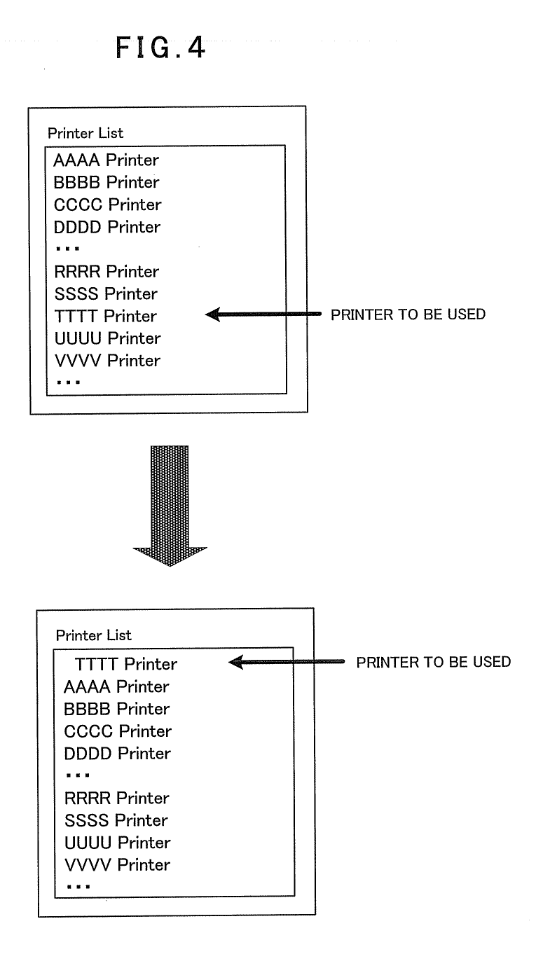

FIG. 4 shows an example of the list of the discovery results obtained by the above-described operation. Suppose that the printer name of the MFP 1 desired by the user is, for example, “TTTT Printer.” Then, when the above-described operation is not executed, the “TTTT Printer” tends to appear low on the list (see the upper part of FIG. 4). When the display area of any of the devices 3A to 3D is limited, only high-ranked printers on the list are displayed, and the MFP 1 is not recognized by the user unless the user operates, for example, a ruler icon on the screen.

However, when the MFP 1 having the name “TTTT Printer” executes the above-described operation by itself, the printer name is listed high on the displayed list as shown in the lower part of FIG. 4. Since users tend to select a printer listed high on the displayed list, the frequency of the use of the MFP 1 increases.

The above-described operation is executed at the timing desired by a user such as a system administrator, at the startup of the printer, or regularly. The above-described operation may be executed according to the setting by the user. The advantages of the use of a space character as the prefix are that the space character is the smallest code in the ASCII code system (except for control characters) and that the original printer name is not greatly changed.

In this embodiment, the MFP 1 itself recognizes printers in the network, and can dynamically change the own name of the MFP 1 to a name with a smaller value in ASCII code order (an alphabetically earlier name) than those of the printers in the network. Therefore, when a printer to be used mainly has been determined, this printer can be listed high on the displayed list, so that users can easily find and select this printer. This can reduce the effort of registering the printer.

This embodiment can be applied to protocols with various currently existing standards and specifications in which the zero configuration technology is used. Therefore, this embodiment can be used for various protocols.

This embodiment can be used even for the case in which, in an environment in which a plurality of printers are used by a plurality of teams, a single printer is preferentially used.

With this embodiment, services such as management of printers using, for example, a server and disclosure of a list to clients are not necessary, and the display of a printer list can be changed by a printer itself without introduction of a new server. Since the desired printer is listed high on the displayed list, users can easily select the desired printer. When the printers are listed in reverse ASCII code order, the printer to which this embodiment is applied appears low on the displayed list. However, even in this case, this printer can be more easily found than printers in the middle of the list.

In this embodiment, a space character is added to the beginning of a printer name in order for the resultant printer name to be listed high on the displayed list of the discovery results. However, any character or character string specified by a user may be added to the beginning of the printer name. In this case, the printer names of all printers having such a function are displayed in a certain part of the list of the discovery results. Suppose that the character string specified by the user is, for example, “CCCC_.” Then all the printers having the above-described function are displayed at positions corresponding to “C” in alphabetical order. Since all the desired printers are displayed in a certain part, the user can more easily find such printers than when these printers are distributed over the list. Even when the user can specify a character string used as the prefix as described above, the user can select a space character. When a space character is specified, the resultant printer name is listed high on the displayed list of the discovery results.

Printer names with a space character used as their leading character are not frequently used and are rare. Therefore, even when a character string in which a space character is used as at least its leading character and the other characters are set arbitrarily is added to the beginning of a printer name, the resultant printer name can be listed high on the list of the discovery results.

### Second Embodiment

In a second embodiment, a description will be given of an exemplary implementation in which a candidate list of prefixes is pre-stored in the storage unit in the MFP and an appropriate term is selected from the prefix list to generate a new printer name when the printer is named. The configuration of the second embodiment is the same as the configuration of the first embodiment (see FIGS. 1 and 2).

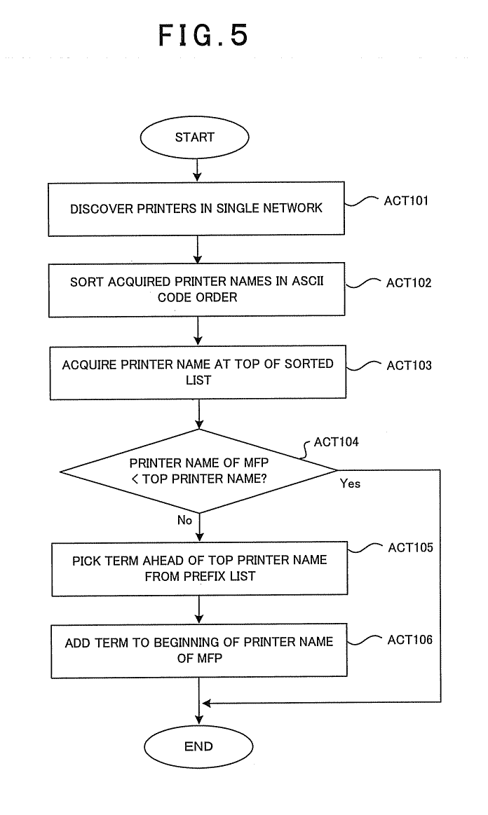

FIG. 5 is a flowchart showing an example of an operation in the second embodiment. Also in the following description, the operation is executed on the MFP 1. The operation in ACT101 to ACT104 is the same as the operation in ACT001 to ACT004 in the first embodiment.

In ACT104, if the value of the own name of the MFP 1 is later in ASCII code order than the value of the printer at the top of the list (ACT104, No), the processor 11 picks, from the prefix list pre-stored in the storage unit 13, a term that is earlier than the name of the printer at the top of the list (ACT105). The processor 11 adds the picked term to the beginning of the printer name of the MFP 1 (ACT106).

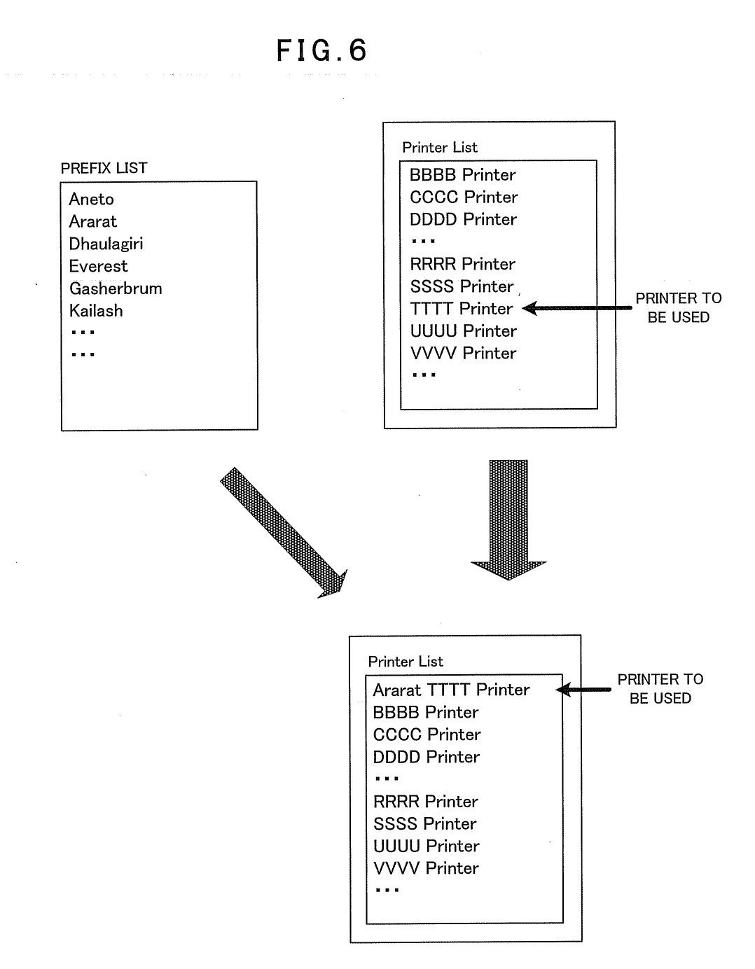

ACT105 and ACT106 will be described with reference to FIG. 6. In the example in FIG. 6, the character string of the name of the printer at the top of the list is “BBBB Printer,” and the character string of the own name of the MFP 1 is “TTTT Printer.” In this case, the processor 11 picks, from the prefix list, a term that is immediately ahead of “BBBB Printer” in ASCII code order. Since the term immediately ahead of “B” in ASCII code order is “Ararat,” the processor 11 adds “Ararat” as a prefix to the beginning of the printer name of the MFP 1 to change it to “Ararat TTTT Printer.”

Also in this embodiment, the own name of the MFP 1 can be listed high on the list. Of course, the user can modify and set the prefix list, and the prefix list with the modified settings is stored in the storage unit 13 and used. In this embodiment, a term immediately ahead in ASCII code order is picked from the prefix list. However, any term can be picked so long as it is ahead of the name of the printer at the top of the list. In the example in FIG. 6, “Aneto” may be picked.

### Third Embodiment

In a third embodiment, a description will be given of the case in which there are a plurality of printers having the functions in the first and second embodiments (these are referred to as printer name changing functions). When there are a plurality of printers having the printer name changing functions in a network, these functions may conflict with themselves. For example, in the first embodiment, when a printer changes its name to a name with a space character at the beginning, another printer changes its name to a name with two space characters added to the beginning. If this operation is executed regularly, the number of space characters increases each time this operation is executed.

Therefore, in the third embodiment, the printers are controlled such that the printer name changing functions are enabled on only one printer and disabled on the other printers. The configuration of the third embodiment is the same as the configuration of the first embodiment (see FIGS. 1 and 2).

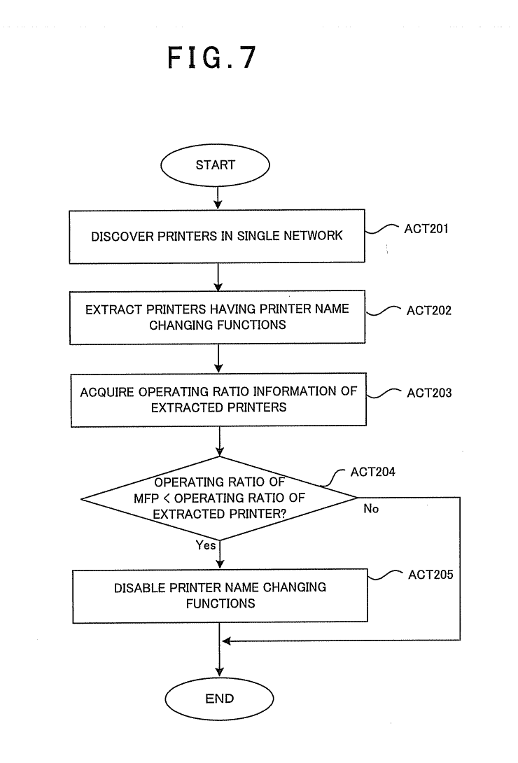

FIG. 7 is a flowchart showing an example of an operation of the MFP 1 in the third embodiment. First, as in the first embodiment, the processor 11 instructs the network I/F 12 to send a broadcast to acquire electronic reply messages including the device names and settings of the printers 2A to 2N (ACT201). Then the processor 11 determines whether or not the acquired settings (capability settings) of each printer include a value indicating the presence of the printer name changing functions to thereby extract one or a plurality of printers having the printer name changing functions (ACT202). In this example, the printers 2A and 2B are extracted. If no printer has the printer name changing functions, the process is ended with the printer name changing functions of the MFP 1 being enabled.

The processor 11 acquires information about the operating ratios of the extracted printers 2A and 2B from the printers 2A and 2B using a prescribed protocol (ACT203). The operating ratio is a value indicating the operation frequency of a printer such as the number of printed sheets per unit time or power consumption. When a mechanism for measuring the operating ratio is provided, this mechanism is used to acquire the information about the operating ratio. If this mechanism is not provided, the output log is referenced to determine the operating ratio. To implement ACT203, the processor 11 may acquire time information and the information about the number of printed sheets from the respective printers 2A and 2B and compute their operating ratios. Alternatively, each of the printers 2A and 23 may compute the operating ratio and send the computation results to the processor 11.

The processor 11 computes the operating ratio of the MFP 1 itself and compares the operating ratio of the MFP 1 with the operating ratios of the printers 2A and 2B (ACT204). If the operating ratio of the MFP 1 is lower, i.e., is not the highest operating ratio among the operating ratios of the printers having the printer name changing functions (ACT204, Yes), the printer name changing functions of the MFP 1 are disabled (ACT205). If the operating ratio of the MFP 1 is higher, i.e., is the highest operating ratio among the operating ratios of the printers having the printer name changing functions (ACT204, No), no operation is performed, and the printer name changing functions are kept being enabled.

The above process is executed on each of the printers having the printer name changing functions. Therefore, only a device having a high operating ratio in the network is operated with these functions being enabled, and the occurrence of conflict can thereby be suppressed. To use a printer with a low operating ratio preferentially, the determination criterion for the magnitude of the operating ratio in ACT204 is reversed. In this manner, the printer with a low operating ratio can be listed high on the list.

In this embodiment, the printer name changing functions of respective printers are enabled or disabled using the operating ratio of the printer. However, the embodiment is not to particular ones. Any other modes can be used so long as the printers in the network can be controlled such that the printer name changing functions are executed on one printer and are not executed on the other printers. Various other implementation methods may be used. For example, the printer name changing functions of a printer with the smallest IP address (or the largest IP address) are enabled, and the printer name changing functions of the other printers are disabled.

### Fourth Embodiment

A fourth embodiment will next be described. In the third embodiment, when a plurality of printers having the functions of the first and second embodiments (the printer name changing functions) are present in the network, these functions are enabled on only one printer. However, in the fourth embodiment, these functions are executed simultaneously on all the printers in the network. As in the above embodiments, the configuration of the fourth embodiment is the same as the configuration of the first embodiment (see FIGS. 1 and 2).

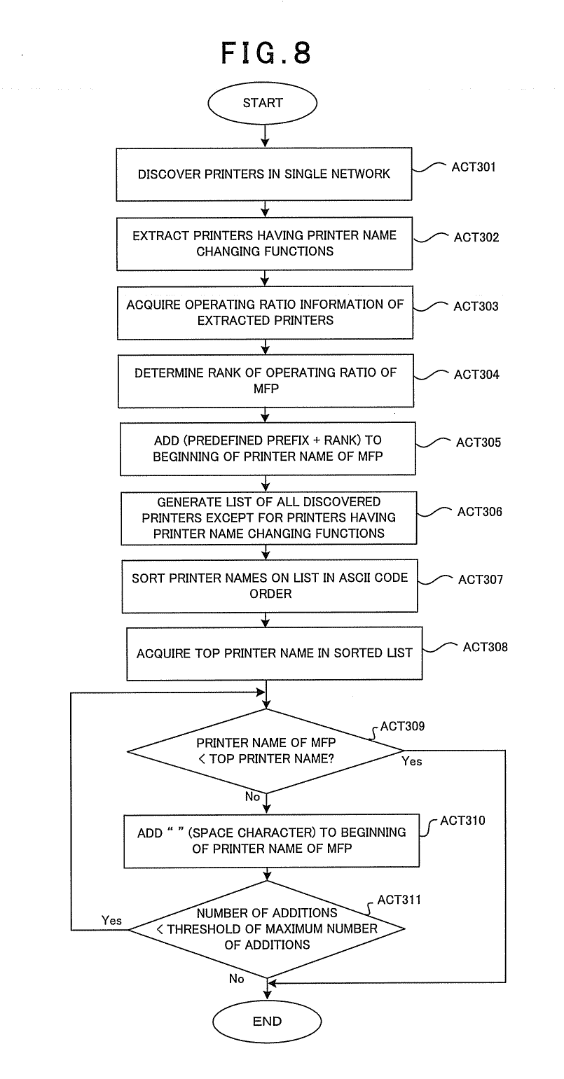

FIG. 8 is a flowchart showing an example of an operation of the MFP 1 in the fourth embodiment. The operation in ACT301 to ACT303 is the same as the operation in ACT201 to ACT203 in the third embodiment.

The processor 11 compares the operating ratio of the MFP 1 with the operating ratios of the printers acquired in ACT303 to determine the rank of the operating ratio of the MFP 1 among the printers with the printer name changing functions in the network (ACT304). After the rank is determined, the processor 11 adds a character string including a combination of a predefined prefix and the determined rank to the beginning of the current printer name of the MFP 1, and the resultant name is used as the printer name of the MFP 1 (ACT305). In this example, only the ranks in the character strings are used to distinguish the printers having the printer name changing functions from each other, as described above.

Then the processor 11 removes the printers having the printer name changing functions from the printer list discovered in ACT301 and generates a list of the names of the remaining printers sorted in ASCII code order (ACT306 and ACT307). The processor 11 acquires the name of a printer at the top of the generated list (ACT308).

The operation in ACT309 to ACT311 is the same as the operation in ACT004 to ACT006 in the first embodiment. More specifically, the processor 11 compares the own name of the MFP 1 with the name of the printer at the top. If the name of the MFP 1 is later in ASCII code order (ACT309, No), a space character is added to the beginning of the name of the MFP 1 (ACT310). Then ACT309 and ACT310 are repeated prescribed times (“Yes” loop in ACT311).

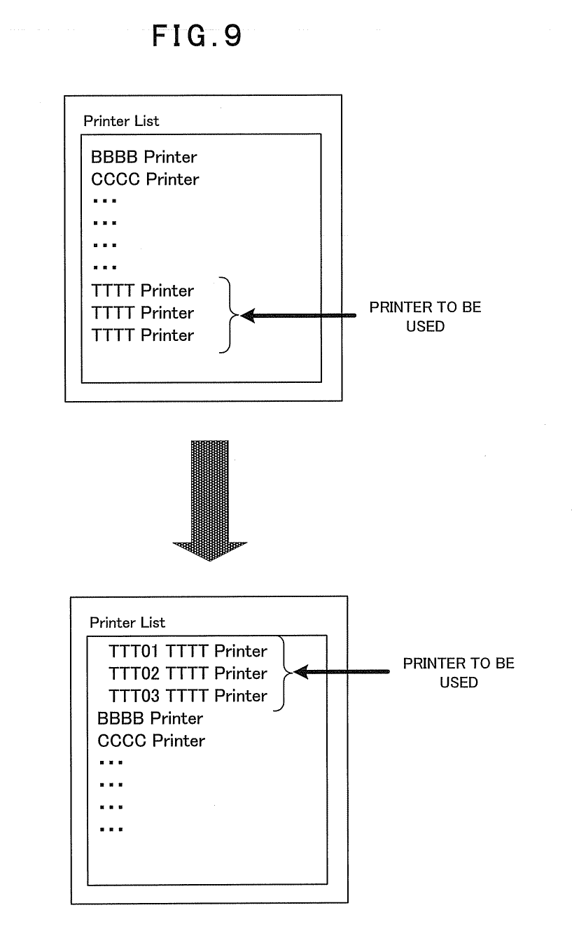

The changes in the ranks on the list by the above-described operation will be described with reference to FIG. 9. FIG. 9 shows an example in which three printers having the printer name changing functions are present in the network (the name of each printer is “TTTT Printer”). In this example, the predefined prefix is “TTT,” and the rank of the operating ratio is represented by a two-digit number. When no printer name changing functions are used in the system and this embodiment is not applied, the ranks of the printers with the names “TTTT Printer” are low on the list, as shown in the upper part of FIG. 9. When the printer name changing functions are enabled to apply this embodiment, a character string including a space character, the predefined prefix, and a two-digit number in that order is added to the beginning of each printer name. Therefore, “TTT01 TTTT Printer,” “TTT02 TTTT Printer,” and “TTT03 TTTT Printer” in that order are listed high on the list (see the lower part of FIG. 9).

### Fifth Embodiment

The first to fourth embodiments are implementation examples in which the names of the printers present in the network are discovered to determine the name of the MFP 1. A fifth embodiment is different from the first to fourth embodiments and is an implementation example in which the name of the MFP 1 is generated by the MFP 1 itself without using the name of other printers. More specifically, each printer generates its printer name independently to change the own name of the printer. As in the above embodiments, the configuration of the fifth embodiment is the same as the configuration of the first embodiment (see FIGS. 1 and 2).

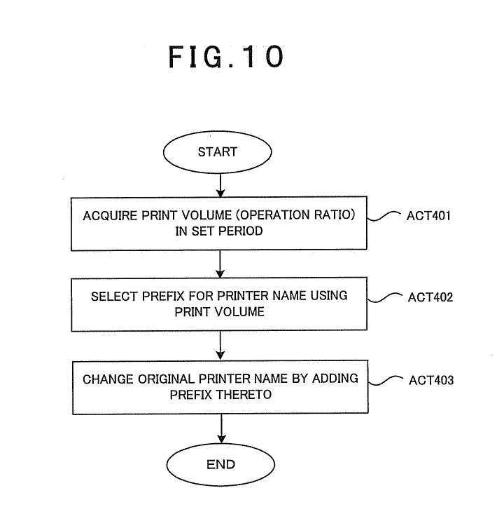

An example of an operation of the MFP 1 in the fifth embodiment is shown in a flowchart in FIG. 10.

The processor 11 acquires a print volume in a period representable by time, day, week, month, and year from log data containing the accumulated operation details of the MFP 1 and stored in the storage unit 13 (ACT401). The processor 11 computes an evaluation value using information acquired from the log data of the MFP 1 and including the print volume and the operating ratio in a specific period and then selects a term from a prefix list stored in the storage unit 13 according to the evaluation value (ACT402). Then the processor 11 adds the selected term to the beginning of the current printer name to change the printer name (ACT403). The changed printer name is overwritten and stored in the storage unit 13, sent to other devices using the zero configuration technology, and used by the other devices.

The simplest threshold value (value) used to compute the evaluation value can be determined using, for example, the following formula:

F(x)=(x/a)*bi

(i=1, 2, 3, . . . , n).

Here, “x” is the print volume (which is the number of printed sheets but may be the number of print jobs) in a certain period, “a” is a level number (the number of prefixes registered in the prefix list), and “bi” is an adjustable value (parameter) of a printer. The prefix list may be the list used in the second embodiment or a list in which terms such as “01_{—},” “02_,” “xx_,” and “(a space character)_xx_” have been registered. The matching between the evaluation value of a printer and a prefix can be changed by changing the adjustable value of the printer. To preferentially use printers with large print volumes, i.e., with large operating ratios, prefixes having small ASCII codes such as “01_{—},” “02_, and “(a space character)_xx_” are mapped to these printers in descending order of the computation results (F(x)) in the above formula. In this manner, such printers are listed high on the list displayed when a printer is selected. To balance between the operating ratios of a plurality of printers, the settings of these printers are changed such that reverse order mapping is performed. In this manner, printers with low operating ratios are listed high on the displayed printer list.

In the method shown in this example, a printer name is generated according to the number of print events executed in a collection period. However, the collection period can be freely set. For example, the number of print events executed in a specific time zone or by a specific user may be used. The print volume is used for the determination, but a printer name can be generated based on power consumption. The log data outputted from each device includes various types of data, and therefore various types of implementations are available.

A procedure described in one of the first to fifth embodiments may be combined with one or a plurality of the other embodiments.

In the above embodiments, the image forming device connected to the network has been described as an example of the network connectable device, but the embodiments are not limited thereto. The above embodiments can be applied to any device that can be connected to a network, such as a printer or a POS terminal connected to the network.

In the above embodiments, the order of the magnitudes of the character strings of the printer names is determined using ASCII codes. However, the use of the ASCII codes is not limited, and any code system readable by computers may be used. There are various code systems such as EBCDIC, Unicode, and language specific character codes (e.g., ISO-2022-JP, EUC-JP, and Shift_JIS used for Japanese). Any of these code systems can be used for the above embodiments.

Whether any of the functions described in the first to fourth embodiments is enabled or disabled can be determined according to the standards and specifications of an application or protocol using the zero configuration technology. When the discovery results are not listed in character code order or are listed in the order received during discovery, the order on the list is not changed even when the name of a device is changed. Therefore, in such a case, the functions described in the first to fourth embodiments may be disabled.

In the description of the above embodiments, the functions are pre-stored in the devices, but the embodiments are not limited thereto. The devices may download similar functions through the network, or similar functions having been recorded on a recording medium may be installed in each device. Any recording medium such as a CD-ROM can be used so long as it can record a program such that a device can read the program. The functions pre-installed or downloaded may cooperate with the OS (operating system) etc. of the devices to enable the features of the functions.

As described above, according to the technique described in the present description, a device to be preferentially used can be easily selected from a plurality of devices.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A network connectable device comprising:
a memory configured to pre-store name information of the network connectable device;
a processor configured to acquire the name information from the memory, add first information including a prescribed character or character string to a beginning of the name information, and store the resultant name information in the memory; and
an interface configured to receive an electronic message and send the name information stored in the memory and having the first information added to the beginning.

2. The device according to claim 1, wherein
at least a leading character of the first information is a space character.

3. The device according to claim 1, wherein
the interface is further configured to send an electronic message and receive, from at least one external device, name information of the at least one external device,
the processor is further configured to acquire the name information of the at least one external device, the name information of the at least one external device being listed first in character cord order, and
the processor is further configured to compare the name information of the network connectable device with the name information listed first and further configured to, when the name information of the network connectable device is behind the name information listed first in character code order, add a character or character string ahead of the name information listed first in character code order to the beginning of the name information of the network connectable device, the character or character string being used as the first information.

4. The device according to claim 3, wherein
the memory is further configured to pre-store a term list, and
the processor is further configured to acquire, from the term list, one term based on the name information listed first and add the acquired term to the beginning of the name information of the network connectable device as the first information.

5. The device according to claim 3, wherein
the interface is further configured to receive second information indicating whether or not the at least one external device performs an operation identical to a first operation including a series of operations performed cooperatively by the memory, the processor, and the interface, and
the processor is further configured to acquire the second information and determine according to a value of the second information whether the first operation is enabled or disabled.

6. The device according to claim 3, wherein
the interface is further configured to receive second information indicating whether or not the at least one external device performs an operation identical to a first operation including a series of operations performed cooperatively by the memory, the processor, and the interface and further configured to, when a value of the second information indicates that the at least one external device performs the operation identical to the first operation, receive information about an operation frequency of the at least one external device therefrom, and
the processor is further configured to compare the information about an operation frequency of the network connectable device with the information about the operation frequency of the at least one external device to thereby rank the network connectable device and the at least one external device, then add a character string including a combination of the rank of the network connectable device and the first information to the beginning of the name information of the network connectable device, and store the resultant name information in the memory.

7. The device according to claim 1, wherein
the memory is further configured to store an operation log, and
the processor is configured to generate a character string based on the operation log stored in the memory, add the character string to the beginning of the name information, and store the resultant name information in the memory.

8. A method of changing a name of a network connectable device,
the method comprising
acquiring name information of the network connectable device from a memory,
adding first information including a prescribed character or character string to a beginning of the name information and storing the resultant name information in the memory, and
receiving an electronic message and sending the name information stored in the memory and having the first information added to the beginning.

9. The method according to claim 8, wherein
at least a leading character of the first information is a space character.
